(19) United States
(12) Patent Application Publication
(10) Pub. No.: US 2010/0053339 A1
(43) Pub. Date: Mar. 4, 2010

(54) DIAGNOSTIC ERROR CODE

(76) Inventors: Erik Aaron, Laguna Hills, CA (US); Frank DiVito, Yorba Linda, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/544,388

(22) Filed: Aug. 20, 2009

Related U.S. Application Data
(60) Provisional application No. 61/093,643, filed on Sep. 2, 2008.

(51) Int. Cl. H04N 17/02

(52) U.S. Cl. 348/189; 348/E17.004

(57) ABSTRACT

Systems and methods that facilitate a multi-color error code recognition system. In a one embodiment, the device includes a micro processor based control system and one or more LED indicators coupled to the control system and capable of emitting two or more colors of light. In operations, the control system detects a failed mechanism in the device and causes the one or more LED indicators to blink in a first color a number of times corresponding to the first digit of the error code and then blink in a second color a number of times corresponding to the second digit of the error code.

### CROSS-REFERENCE TO RELATED APPLICATION

This application claims the benefit of provisional application Ser. No. 61/093,643 filed Sep. 2, 2008, which is fully incorporated herein by reference.

### FIELD

The embodiments described herein relate generally to device failure mode recognition and, more particularly, to systems and methods that facilitate a multi-color error code recognition system.

### BACKGROUND INFORMATION

Failure mode recognition and service related thereto can be time consuming and fraught with frustration. Current failure recognition systems typically utilizes a single color LED (green) for failure code indication. The LED blinks green a certain number of times to indicate the first digit of the failure code. Then, after a half second pause, the green LED blinks a certain number of times to indicate the second digit of the code. The two digits combined designate failure code corresponding to the failed mechanism within the product.

It is desirable to provide systems and methods that simplify this process.

### SUMMARY

The embodiments provided herein are directed to systems and methods that facilitate a multi-color error code recognition system. Although applicable to a variety of electronic devices, the example embodiments provided herein are discussed in regard to televisions. In a one embodiment, the television includes a micro processor based control system and one or more LED indicators coupled to the control system and capable of emitting two or more colors of light. In operations, the control system detects a failed mechanism in the device, identifies an error code corresponding to the failed mechanism and causes the one or more LED indicators to blink in a first color a number of times corresponding to the first digit of the error code and then blink in a second color a number of times corresponding to the second digit of the error code

In an alternative embodiment, the one or more LED indicators are capable of emitting more than two colors of light to facilitate an error code recognition system for error codes having three or more digits.

Other systems, methods, features and advantages of the example embodiments will be or will become apparent to one with skill in the art upon examination of the following figures and detailed description.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television and control system.

FIG. 2 is a schematic showing a error code recognition process process.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce systems and methods to facilitate error code recognition. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

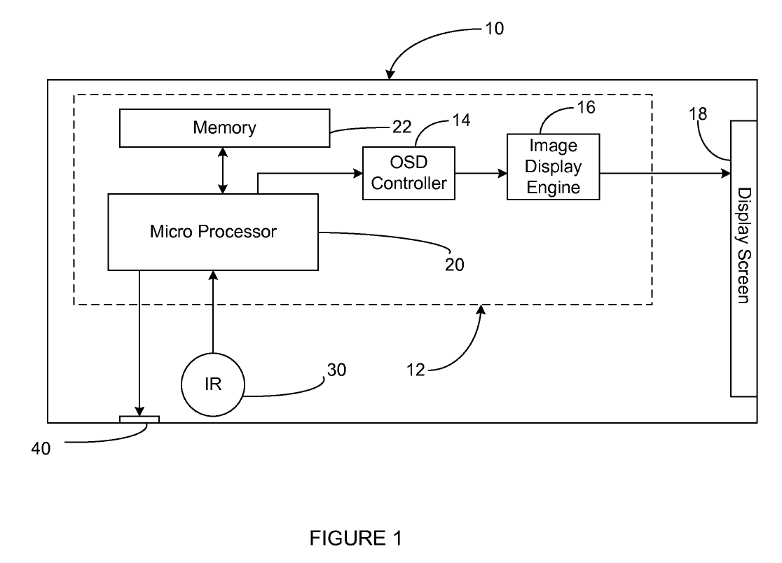

The systems and methods described herein are directed to an improved error code recognition system. Turning in detail to the figures, FIG. 1 depicts a schematic of an embodiment of a television 10. The television 10 preferably comprises a video display screen 18, a control system 12 including a micro processor 20 and non-volatile memory 22 upon which system software and system error or failure codes are stored, an on screen display (OSD) controller 14 coupled to the micro processor 20, and an image display engine 16 coupled to the OSD controller 14 and the display screen 18. The system software preferably comprises a set of instructions that are executable on the micro processor 20 to enable the setup, operation and control of the television 10 and the monitoring of the television systems and components for errors or failures.

As depicted, the television 10 also includes an LED indicator system 40 coupled to the control system 12. The LED indicator system 40 is preferably capable of emitting two or more different colors of light. In one embodiment, the LED indicator system 40 preferably includes two or more LEDs each capable of emitting a different color of light.

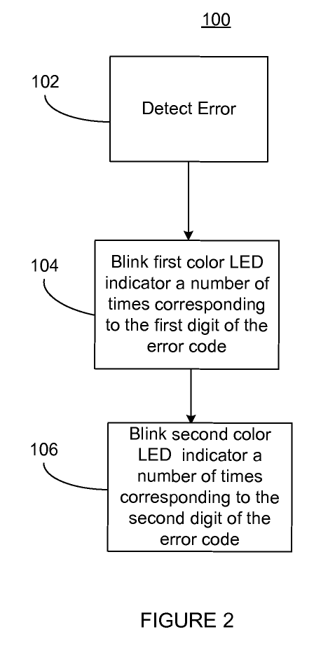

Turning to FIG. 2, in an error recognition mode 100, the control system will detect, at step 102, an error or failure in the system, and look up or identify an error or failure code corresponding to the error or failure in the system. At step 104, the LED indicator system 40 blinks a first color a number of times corresponding to the first digit of an error code. At step 106, the LED indicator system 40 blinks a second color a number of times corresponding to the second digit of the error code.

The use of more than one color makes it easier to count the number of blinks and separate the digits. Both consumer and phone operator will be able to communicate the error code to the service technician and will result in a more efficient repair.

In an alternative embodiment, the LED indicator system 40 is capable of emitting more than two colors of light to facilitate an error code recognition system for error codes having three or more digits.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A television comprising
a control system, and
an LED error indication system coupled to the control system and adapted to emit a first color light corresponding to the first digit of an error code and a second color light corresponding to a second digit of the error code.

2. The television of claim 1 wherein the LED error indication system includes one or more LEDs.

3. A television comprising
a control system, and
one or more LEDs coupled to the control system, wherein the one or more LEDs are adapted to emit a first color light corresponding to the first digit of an error code and a second color light corresponding to a second digit of the error code.

4. A method of error indication comprising the steps of
detecting a system or component failure or error,
emitting a first color light corresponding to a first digit of an error code corresponding to the detected failure or error, and
emitting a second color light corresponding to a second digit of an error code corresponding to the detected failure or error.

5. The method of claim 4 wherein the steps of emitting first and second color lights comprises blinking first and second LEDs a number of times corresponding to the first and second digits of the error code.

6. The method of claim 4 wherein the steps of emitting first and second color lights comprises blinking a LED a first color a number of times corresponding to the first digit of the error code and then blinking the LED a second color a number of times corresponding to the second digit of the error code.
